(19) United States
(12) Patent Application Publication
(10) Pub. No.: US 2012/0221654 A1
(43) Pub. Date: Aug. 30, 2012

(54) TERMINAL AND METHOD FOR PROVIDING A CLOUD SERVICE

(75) Inventor: Se Young PARK, Seoul (KR)

(73) Assignee: PANTECH CO., LTD., Seoul (KR)

(21) Appl. No.: 13/302,482

(22) Filed: Nov. 22, 2011

(30) Foreign Application Priority Data
Feb. 25, 2011 (KR) 10-2011-0017150

(51) Int. Cl. G06F 15/16

(52) U.S. Cl. 709/206; 709/217

(57) ABSTRACT

An apparatus and a method for providing a cloud service, where the method includes storing information, generated by an input to a terminal or communication data generated between the terminal and another terminal, in a web server; and determining and providing a service based on the information or communication data. The method and apparatus allow for communication data to be shared via a private page between two terminals designated as soul mates.

### CROSS-REFERENCE TO RELATED APPLICATION

This application claims priority from and the benefit under 35 U.S.C. §119(a) of Korean Patent Application No. 10-2011-0017150, filed on Feb. 25, 2011, which is incorporated by reference for all purposes as if fully set forth herein.

### BACKGROUND

1. Field

The following description relates to a method for providing a cloud service and a terminal using the cloud service and, more particularly, to a method for providing a cloud service using communication data and a terminal using the same.

2. Discussion of the Background

Cloud computing relates to software, applications and data that is stored in a large external computer server versus a personal computer or a smart phone, and may be retrieved and used by accessing an external computer server via a network, such as the Internet.

A generally used application, such as web mail (Internet mail) is an example of cloud computing. Although mail may be read by accessing the Internet, a variety of data, such as received mail is not permanently stored in a user's computer, but rather, is stored in a web mail server, or a server of a web mail service provider.

A user may receive desired computing resources through a network, such as the internet, using cloud computing at any time or any location. Computing resources are managed by a resource provider, such as, a mass data center, and include hardware resources, such as CPU capability, a memory and storage, a development platform, an application program, and the like.

A service which is provided by a resource provider in order to utilize computing capability by the computing resources in a terminal is referred to as a cloud computing service.

The cloud computing service may be used through a network for convenience. In particular, if the cloud computing service is used, a high-performance computer or expensive software may not be purchased and as the network and/or internet may be utilized for providing the service. Accordingly, recently, with development of wireless internet, WiFi or 3G networks, cloud computing services are becoming more relevant.

In addition, as portable PCs, such as smart phones and/or tablet PCs have been developed, cloud computing services have also become more relevant for this reason. Although a user may edit and/or manage data using a portable PC, such as, a smart phone or the like, the user of another may not use or view the data. Accordingly, communication with another user may be made difficult.

### SUMMARY

Exemplary embodiments of the present invention provide a method for providing a cloud service for providing a new communication channel, and terminal to execute cloud services, the cloud service utilizing communication between the terminal and another device.

Additional features of the invention will be set forth in the description which follows, and in part will be apparent from the description, or may be learned by practice of the invention.

An exemplary embodiment provides a mobile terminal to execute a cloud computing application, the terminal including: an application execution unit to execute the cloud computing application; a data storage unit to store data associated with the cloud computing application; and a communication unit to communicate with a remote device, wherein the communication unit communicates the data associated with the cloud computing application.

An exemplary embodiment provides a method for sharing information between a mobile terminal and a remote device, the method including: executing a cloud computing application in the mobile terminal; storing data associated with the cloud computing application; and communicating the data associated with the cloud computing application from the mobile terminal to the remote device.

An exemplary embodiment provides system to allow sharing of data, the system including: a mobile communication terminal and remote device, each including: an application execution unit to execute a cloud computing application; a data storage unit to store data associated with the cloud computing application; and a communication unit to communicate the data associated with the cloud computing application on a network; and a display unit to view a private page based on the data associated with the cloud computing application.

It is to be understood that both the foregoing general description and the following detailed description are exemplary and explanatory and are intended to provide further explanation of the invention as claimed. Other features and aspects will be apparent from the following detailed description, the drawings, and the claims.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a conceptual diagram of a terminal using a cloud service according to an exemplary embodiment.

FIG. 2 and FIG. 3 are diagrams illustrating a data management function of the cloud service according to an exemplary embodiment.

FIG. 4 is a conceptual diagram of a cloud system illustrating a messenger function according to an exemplary embodiment.

FIG. 5 is a conceptual diagram of a cloud system with a sharing function according to an exemplary embodiment.

FIG. 6 is a conceptual diagram of a cloud system with a diary function according to an exemplary embodiment.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION OF THE ILLUSTRATED EMBODIMENTS

Exemplary embodiments now will be described more fully hereinafter with reference to the accompanying drawings, in which exemplary embodiments are shown. The present disclosure may, however, be embodied in many different forms and should not be construed as limited to the exemplary embodiments set forth therein. Rather, these exemplary embodiments are provided so that the present disclosure will be thorough and complete, and will fully convey the scope of the present disclosure to those skilled in the art. In the description, details of well-known features and techniques may be omitted to avoid unnecessarily obscuring the presented embodiments.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. Furthermore, the use of the terms a, an, etc. does not denote a limitation of quantity, but rather denotes the presence of at least one of the referenced item. The use of the terms “first”, “second”, and the like does not imply any particular order, but they are included to identify individual elements. Moreover, the use of the terms first, second, etc. does not denote any order or importance, but rather the terms first, second, etc. are used to distinguish one element from another. It will be further understood that the terms “comprises” and/or “comprising”, or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

It will be understood that for the purposes of this disclosure, “at least one of X, Y, and Z” can be construed as X only, Y only, Z only, or any combination of two or more items X, Y, and Z (e.g., XYZ, XYY, YZ, ZZ).

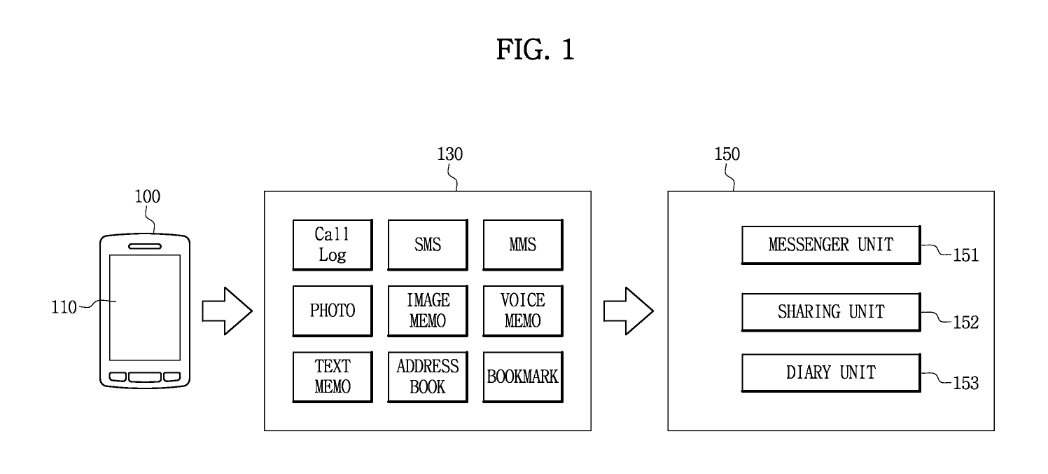

FIG. 1 is a conceptual diagram of a terminal using a cloud service according to an exemplary embodiment.

Referring to FIG. 1, a terminal 100 includes a display unit 110, a data unit 130 to store data, and a communication unit 150 to provide a cloud service. The data unit 130 and the communication unit 150 may be disposed in the terminal 100, but are shown outside the terminal 100 for convenience.

The terminal 100 may include various communication devices which may access the internet, such as a smart phone, a tablet PC, a personal digital assistant (PDA), and a netbook. In this disclosure, the term internet is used; however, aspects of the disclosure are not limited thereto, and the various devices may access and communicate with any appropriate network.

The data unit 130 stores information input by a user or communication data generated by communication with another terminal in an external web server. The user may be a person who uses the terminal 100.

The data unit 130 may store data of at least one of a call log, a short messaging service (SMS), a multimedia messaging service (MMS), a photo, an image memo, a voice memo, a text memo, an address book, a bookmark and the like.

The call log, the SMS and the MMS are communication data generated if the terminal 100 communicates with another terminal.

The photo, the image memo, the voice memo, the text memo, the address book and the bookmark are information generated by the user.

The communication unit 150 executes the cloud service using the data stored in the web server. The communication unit 150 determines a service to provide according to the information or communication data stored in the web server, and provides the cloud service according to the result of determination.

For example, the communication unit 150 may include a messenger unit 151 to execute a messenger function, a sharing unit 152 to execute a sharing function and a diary unit 153 to execute a diary function.

The functions executed by the data unit 130 and the communication unit 150 may be displayed on the display unit 110 in the form of an icon and/or text. The execution of the messenger function, the sharing function and the diary function of the communication unit 150 will be described below in more detail.

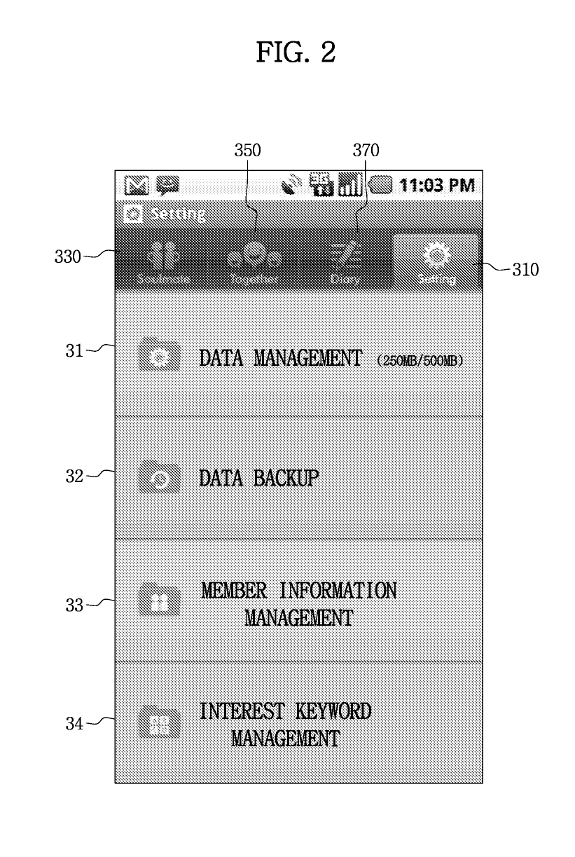

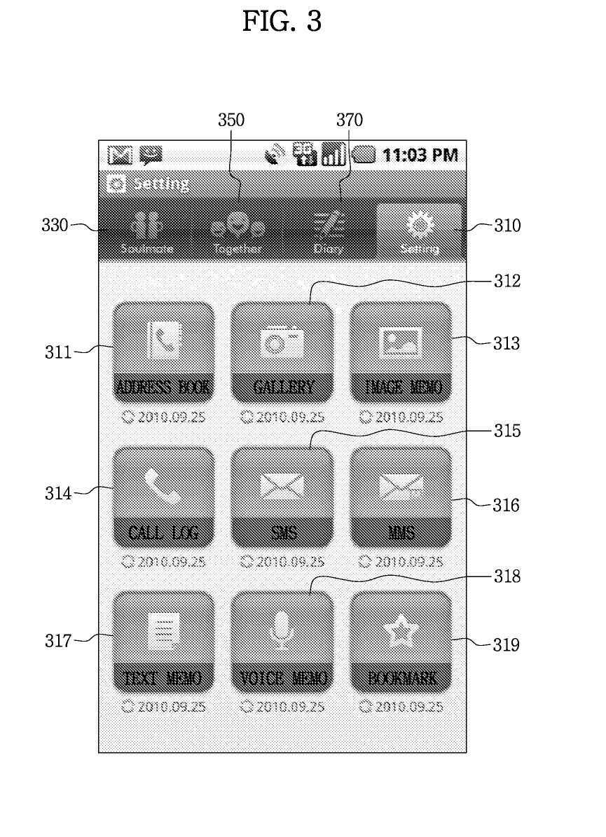

FIG. 2 and FIG. 3 are diagrams illustrating a data management function of the cloud service according to an exemplary embodiment.

Referring to FIG. 2, icons representing functions provided by the cloud service are arranged at an upper portion of the display unit 110 of the terminal 100. However, the placement of the icons are not limited thereto.

The icons may represent various available functions, such as Soul Mate 330, which is a messenger function of the cloud service, Together 350, which is a sharing function, Diary 370 which is a diary function, and Setting 310, which is a data management function. However, the above-described icons are only exemplary and names and designs thereof may be substituted.

Referring once again to FIG. 2, an example display of the display unit 110 while the data management function of the cloud service is executed, is shown. The user may select Setting 310, which represent the data management function, to edit and manage the data.

If the data management function is executed, a data management function 31, a data backup function 32, a member information management function 33, and an interest keyword management function 34 may be presented and shown on the display, and selected for execution.

FIG. 3 shows an example of a screen displayed on the display unit 110 if the data backup function 32 shown in FIG. 2 is executed. As shown in FIG. 3, if the data backup function 32 is executed, data to be backed up is displayed.

The data to be backed up may be displayed by icons of an address book 311, a gallery 312, an image memo 313, a call log 314, an SMS 315, a MMS 316, a text memo 317, a voice memo 318 and a bookmark 319. The data, in FIG. 3, to be backed up is exemplary. Data to be backed up may be added, deleted or customized according to a service change and user demand/preferences.

The user may selectively back the data up. Dates when the data is backed up may be displayed below or above icons. The date display may be placed in other locations based on a user preference.

The user may selectively back up the data stored in the data unit 130, and the backed-up data may be uploaded from the terminal 100 to the external web server or a remote device. Remote may not indicate a minimum physical distance of separation between the terminal and the remote device, and instead may merely refer to two devices that are communicating through the internet or a network, including a local network, even if there little or no physical separation between the terminal and remote device.

The user may download the data stored in the web server to the terminal 100 and the downloaded data may be stored in the data unit 130.

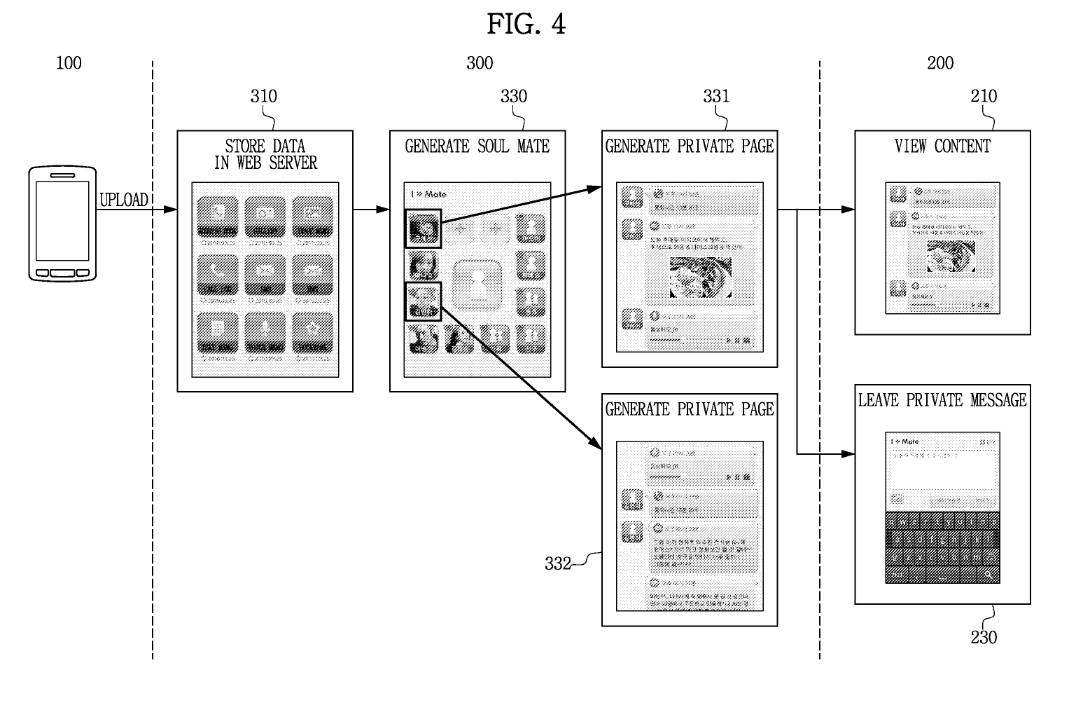

FIG. 4 is a conceptual diagram of a cloud system illustrating a messenger function according to an exemplary embodiment.

Referring to FIG. 4, the cloud system includes a user terminal 100, a web server 300 and a counterpart's terminal 200. The counterpart's terminal is defined as a terminal of another party who communicates with the user.

The user may selectively upload part or all of the information or communication data to the web server 300 via the terminal 100.

The user may execute the messenger function to set the counterpart's terminal 200 as a soul mate. The soul mate may be designated using information stored in the address book 311.

The user may select Soul Mate 330, which is a messenger function of the cloud service, so as to confirm the counterpart's terminal 200 as a soul mate. The number of soul mates may be one or more and one or more soul mates may be grouped and managed.

The user may add, delete or modify a group of soul mates. Alternatively, the user may manage a soul mate, that is, add or delete a soul mate, move a soul mate to another group, or remove a soul mate from a group.

If the counterpart's terminal 200 is designated as the soul mate, a private page associated with the counterpart's terminal 200 is generated. On the private page of the counterpart's terminal 200, communication data generated by communication between the terminal 100 and the counterpart's terminal 200 is displayed.

In more detail, on the private page, communication data transmitted from the terminal 100 to the counterpart's terminal 200 and communication data transmitted from the counterpart's terminal 200 to the terminal 100 may be displayed.

Further, information about the counterpart's terminal 200 communicating with the terminal 100 may be stored in the web server. The information about the counterpart's terminal 200 may include various information, such as a telephone number of the counterpart's terminal 200, Subscriber Identity Module (SIM) information, Media Access Control (MAC) information and the like.

The private page of the counterpart's terminal 200 may be viewed by both the terminal 100 but also by the counterpart's terminal 200. That is, the private page of the counterpart's terminal 200 may be shared between the user and the counterpart.

The terminal 100 and the counterpart's terminal 200 may display the private page of the counterpart's terminal 200 and a private message may be left on the private page. Thus, the user of the counterpart's terminal 200 may also update or edit the communication data on the private page.

The communication data may be aligned with a time, such as a current time or a specific time. A date is displayed on a lower end of the display unit 110. The user may change the date and view a private page associated with another date.

At least one piece of communication data with the counterpart's terminal 200 is displayed on the private page. The communication data may include the call log 314, the SMS 315 and the MMS 316 backed up from the terminal 100.

Although the address book 311, the gallery 312, the image memo 313, the text memo 317, the voice memo 318 and the bookmark 319 may be information input by a user, this information may represent communication data generated during the execution of the messenger function. If the information is associated with the communication data, the information may be displayed on the private page of the counterpart's terminal 200.

The number of counterpart's terminals 200 may be one or more. If a plurality of counterpart's terminals 200 is present, a private page is generated with respect to each of the counterpart's terminals 200. The private pages may be shared with the corresponding counterpart's terminals 200.

For example, if a user, “GOO, Hae Seon”, is selected as a soul mate, the display is moved to a private page 331 corresponding to “GOO, Hae Seon”. Communication data between the terminal 100 and “GOO, Hae Seon” is displayed on the private page of “GOO, Hae Seon” and the private page of “GOO, Hae Seon” is shared between the terminal 100 and the terminal of “GOO, Hae Seon” (counterpart's terminal 200).

The user, “GOO, Hae Seon”, may view her private page 210 and may leave a private message 230. The counterpart “GOO, Hae Seon” may update and/or edit her private page.

Similarly, if “KIM, Yuna” is selected as the soul mate, the display is moved to a private page 332 of “KIM, Yuna”. Communication data between the terminal 100 and “KIM, Yuna” is displayed on the private page of “KIM, Yuna” and the private page of “KIM, Yuna” is shared between the terminal 100 and the terminal of “KIM, Yuna” (counterpart's terminal 200).

The above allows for a one-to-one communication channel between a user and a terminal associated with another user.

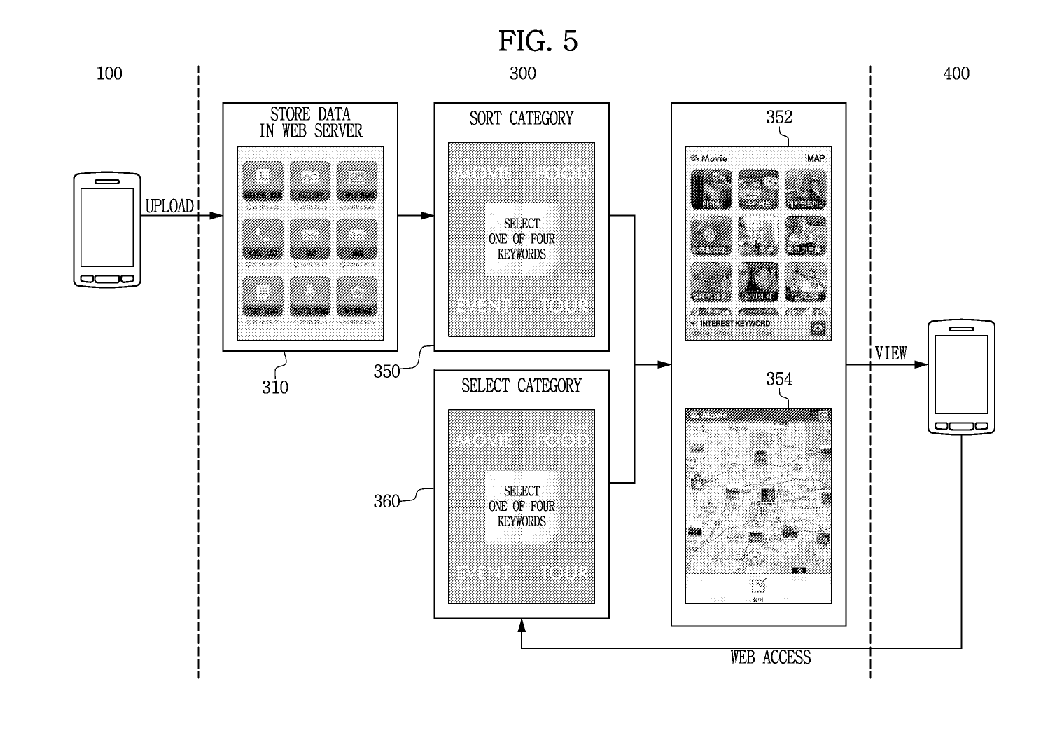

FIG. 5 is a conceptual diagram of a cloud system with a sharing function according to an exemplary embodiment.

Referring to FIG. 5, the user may execute the sharing function, thereby allowing the sharing of information uploaded to the web server 300 with the terminal 400 of a participant. The participant is defined as a person who may share the information regardless of communication with the user. The number of participants may be one or more.

The user may select Together 350, which represents the sharing function of the cloud service, thereby allowing the information to be viewed and uploaded.

The information may be uploaded by a plurality of participants and the uploaded information may be displayed according to an associated category. Examples of categories that may be used may include, but not limited to, MOVIE, FOOD, EVENT, TOUR, etc. A new category may be added or any of such categories may be deleted according to service changes and user demands.

If one of the categories is selected, content corresponding to the category is provided. A list of content may be provided or content may be provided on a map based on an Internet provided mapping service. The content may be displayed in the form of photos or pictures. The method of providing the content may be changed according to a specific user setting.

For example, if MOVIE is selected from the categories, a list 352 representing movie content may be provided and, if TOUR is selected from the categories, content representing tourist attractions may be provided on a map 354.

Even if the terminal 400 has not communicated with the user, the terminal 400 may access the web server 300, to share the information, thereby becoming a participant of the information.

Accordingly, the terminal 400 may access the web server 300, and allow a user to select one of the categories, thereby searching for desired information pertaining to the selected category. The terminal 400 may execute an application such as Together 350, to upload or download content.

The user and the participant (or participants) may set and manage an interest keyword in order to facilitate the search for desired information. For example, the interest keyword may be a phrase or nickname associated with the desired information. The user and the participant may leave a review of the content. For example, reviews of a specific movie or place may be shared and used. Thus, this sharing of content and the reviews associated with the content may increase the collective intelligence of both the user and the participants.

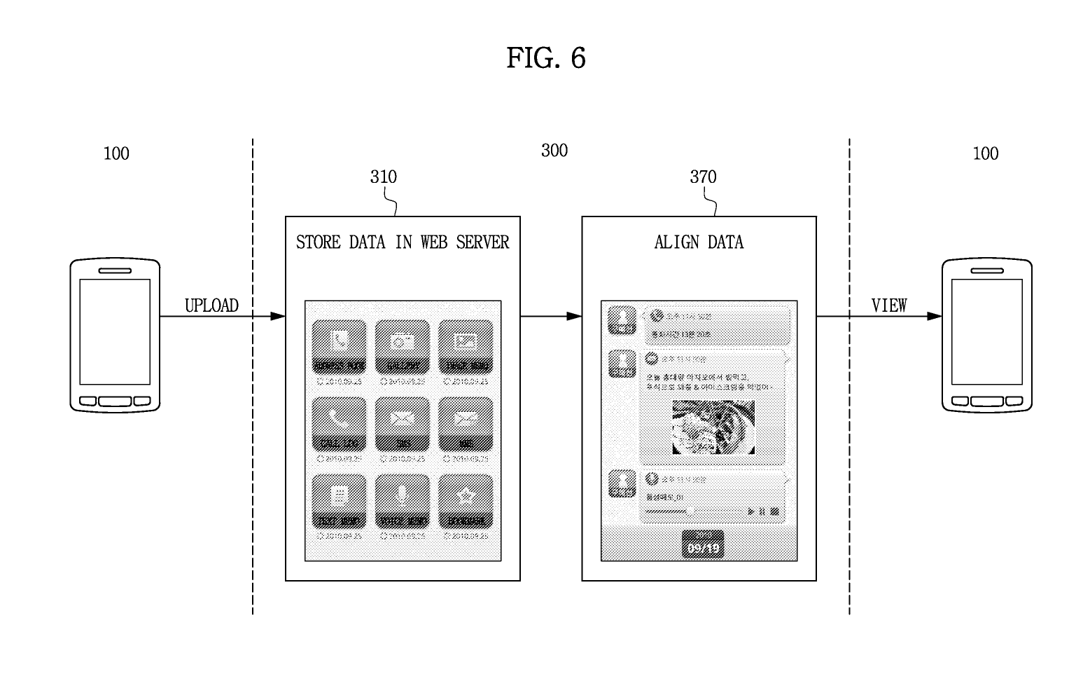

FIG. 6 is a conceptual diagram of a cloud system with a diary function according to an exemplary embodiment.

Referring to FIG. 6, the user may execute the diary function to track and review the user's daily life. A user may prefer to not share their information associated with the diary function with other users, and thus, may be set to be displayed only on the user terminal 100. Thus, it is possible to protect user privacy.

The information or communication data backed up by the user may be automatically updated and provided according to dates and times, such as a current date/time or a specific date/time. The information may be provided according to a user setting. The communication data may wholly or selectively provide communication history with a plurality of other users and their terminals.

The user may select Diary 370, which is a diary function of the cloud service, to view today's information or communication data.

A date is displayed on the lower end of the display unit 110. The user may change the date to view the information or communication data associated with another date.

Without user input, daily information stored in the terminal 100 may be conveniently used as a life memory by automatically backing up the information or communication data.

As described above, it is possible to provide an appropriate service according to a determination, based on either information or communication data. In addition, since a new communication channel is formed, it is possible to prompt the user to use the cloud service, thereby increasing the sales of a terminal using the cloud service in the above described manner.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A mobile terminal to execute a cloud computing application, the terminal comprising:
an application execution unit to execute the cloud computing application;
a data storage unit to store data associated with the cloud computing application; and
a communication unit to communicate with a remote device,
wherein the communication unit communicates the data associated with the cloud computing application.

2. The terminal according to claim 1, further comprising:
a page creating unit to create a private page associated with the data of the cloud computing application,
wherein the communication unit communicates the private page from the mobile terminal to the remote device.

3. The terminal according to claim 1, wherein the cloud computing application is a data management application,
wherein the data management application allows a user of the mobile terminal to select the data associated with the cloud computing application to be communicated

4. The terminal according to claim 2, wherein the cloud computing application is a soul mate application,
wherein the soul mate application allows a selection of a specific device or group of devices to exclusively receive communication of the private page.

5. The terminal according to claim 2, wherein the private page is associated with a specific time.

6. The terminal according to claim 1, wherein the cloud computing application is a together application,
wherein the together application allows sharing of the data associated with the cloud computing application based on a selected category.

7. The terminal according to claim 6, wherein the mobile terminal and the other device share through the together application independent of direct communication with each other.

8. The terminal according to claim 4, wherein the soul mate application allows a user to enter a message to be added to the private page.

9. A method for sharing information between a mobile terminal and a remote device, the method comprising:
executing a cloud computing application in the mobile terminal;
storing data associated with the cloud computing application; and
communicating the data associated with the cloud computing application from the mobile terminal to the remote device.

10. The method according to claim 9, further comprising:
creating a private page associated with the data of the cloud computing application;
communicating the private page from the mobile terminal to the remote device.

11. The method according to claim 9, wherein the cloud computing application is a data management application,
wherein the data management application allows a user of the mobile terminal to select the data associated with the cloud computing application to be communicated.

12. The method according to claim 9, wherein the cloud computing application is a soul mate application,
wherein the soul mate application allows a user of the mobile terminal to select a specific device or group of devices to exclusively receive communication of the private page.

13. The method according to claim 9, wherein the private page is associated with a specific time.

14. The method according to claim 9, wherein the cloud computing application is a together application,
wherein the together application allows a user of the mobile terminal to share the data associated with the cloud computing application based on a selected category.

15. The method according to claim 14, wherein the mobile terminal and the other device share through the together application independent of direct communication with each other.

16. The method according to claim 12, wherein the soul mate application allows a user to enter a message to be added to the private page.

17. A system to allow sharing of data, the system comprising:
a mobile communication terminal and remote device, each comprising:
an application execution unit to execute a cloud computing application;
a data storage unit to store data associated with the cloud computing application; and
a communication unit to communicate the data associated with the cloud computing application on a network; and
a display unit to view a private page based on the data associated with the cloud computing application.

18. The system according to claim 17, wherein the private page contains information selectively allowed by either the terminal or the remote device.

19. The system according to claim 17, wherein the mobile terminal and the remote device are capable of inserting messages on the corresponding private page.

20. The system according to claim 17, wherein the private pages is transmitted to a web server.
